(19) United States
(12) Patent Application Publication
(10) Pub. No.: US 2001/0048860 A1
(43) Pub. Date: Dec. 6, 2001

(54) Tethered screw

(76) Inventors: Harold D. Ross, Chalfont, PA (US); William P. McDonough, Collegeville, PA (US); Brian G. Bentrim, Hatfield, PA (US)

Correspondence Address: Gregory J. Gore, Suite 316, 70 W. Oakland Ave., Doylestown, PA, 18901, US

(21) Appl. No.: 09/864,403

(22) Filed: May 25, 2001

Related U.S. Application Data
(60) Provisional application No. 60/209,627, filed on Jun. 6, 2000.

(51) Int. Cl. F16B 21/18

(52) U.S. Cl. 411/352

(57) ABSTRACT

A narrow, pliable tether or strap attaches at opposite ends to a panel and a screw respectively in order to flexibly retain the screw to the panel away from the screw hole. A variety of attachment means between the tether and the screw may be employed. C-clip style jaws on the end of the tether may be employed to fit into a groove under the head of the screw as the preferred means of releasable screw attachment. Thus, the tether is free to rotate on the screw to avoid binding as the screw is turned. An adhesive, either first applied to the tether or the panel is employed to attach the stationary end of the tether to the panel.

Priority based upon provisional application serial No. 60/209,627 filed on Jun. 6, 2000, entitled “TETHERED SCREW” is hereby claimed.

### FIELD OF THE INVENTION

The present tethered screw invention relates to a screw that can be retained loosely to a panel at low cost.

### BACKGROUND OF THE INVENTION

It Mechanical assemblies comprising a plurality of joined parts often present the problem of loose hardware. In many applications where screws are used, there is the chance of misplacing or losing the loose screws, especially during maintenance. There are many captive-type panel fasteners on the market that address this problem, but in many applications these solutions are too restrictive because the screw remains in the area of the hole. There is therefore a need in the art for means to retain a fastener to the panel when it is unscrewed that will not obstruct the area around the hole and that will be convenient and easy to use.

### SUMMARY OF THE INVENTION

The present tethered screw is a low-cost alternative to a panel fastener. The use of an adhesive and a pliable tether allow for flexibility in positioning the tether on the attached panel. In many applications the tethered screw is a better, or the only, solution to the screw retention problem.

The present invention embodies several variations of a screw retained loosely to a panel, the primary element of which is a narrow, pliable tether or strap that attaches at opposite ends to a panel and a screw. A variety of attachment means to the screw may be employed. C-clip style jaws on the end of the tether which fit into a groove under the head of the screw are the preferred means of releasable screw attachment. The strap is free to rotate on the screw to avoid binding, and is attached to the screw and panel away from the clamp path. A completely circular hole in the tether can work in the undercut groove as well, using the material's compliance to allow it to stretch and fit into the undercut. The preferred configuration utilizes an adhesive to attach the tether to the sheet. This is a non-intrusive means of attachment that does not protrude on the back side of the panel.

Other embodiments of this invention include substituting the adhesive with another means of attachment which could be a pin that snaps into a hole, a plastic or metal rivet, or any other suitable means. Some alternate attachment means lend themselves to being molded directly onto the tether as a single component. Additionally, the attachment jaws could be replaced by a simple hole through the tether which could therefore be positioned concentric to the panel hole so that the screw would pass through the panel attachment end of the tether.

Different materials can be used for the tether. As discussed above, a thin pliable plastic tether is a viable alternative. Mylar is also a possible alternative. Any material could be utilized providing it had enough strength and flexibility.

More specifically, the applicants have invented a tethered fastener attached to a panel having an aperture therein for receiving a screw. The fastener has a head at one end and a threaded elongate shaft extending from the opposite end, the elongate tether having attachment means at one end for affixation to the panel and the second end including attachment means for releasably affixing the end to the head of the screw. The panel affixation means is an adhesive and the tether is composed of nylon. The second attachment means is a C-shaped clip deformable to provide releasable snap-fit engagement with the head of the fastener. The fastener further includes a groove for releasably receiving the C-shaped clip.

Thus, the tethered screw that has been devised provides the advantages of retaining a fastener to a panel when it is unscrewed while not obstructing the area around the hole. It would be readily understood that this has been achieved economically and is convenient to apply. Other objects and advantages will become readily apparent to those with skill in the art from the following drawings and description of the preferred embodiment.

### BRIEF DESCRIPTION OF THE DRAWINGS

FIG. 1 is top left front isometric view of the present invention.

FIG. 2 is a top view of the tether element.

FIG. 3 is a perspective exploded assembly view of the three elements which form the combination of the invention.

FIG. 4 is a close-up view of the screw/tether joint taken from FIG. 3 as shown in that figure.

### DESCRIPTION OF THE PREFERRED EMBODIMENT

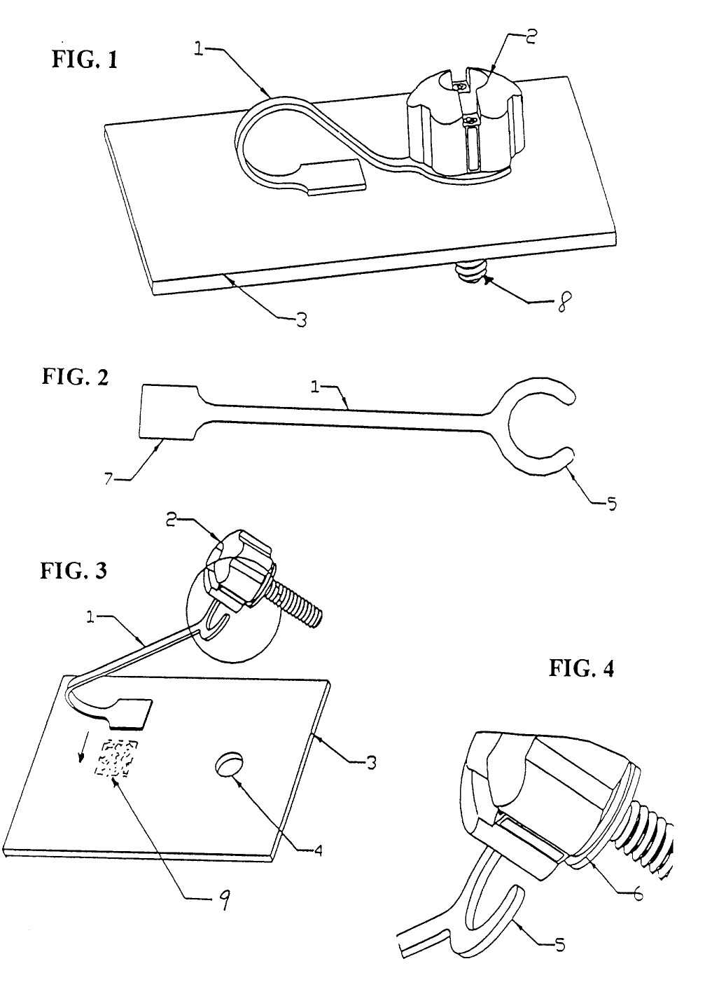

Referring to FIG. 1, a central feature of this invention is a pliable strap or tether 1 that attaches to both a screw 2 and a panel 3 to releasably retain the fastener to the panel when it is unscrewed. The tether 1 has ample length and flexibility to allow the screw 2 to be easily repositioned, and to allow the screw 2 access to a hole or threads that mate with screw threads 8.

Referring to FIG. 2, the tether 1 could be of any material that achieves the required pliability and strength required to allow the rotation and retention of the screw within the jaws 5 of the tether. Preferably, a Nylon® material should be used and either made through a stamping or molding operation. The opposing end of the tether 1 has a tab 7 of increased width to provide additional surface area to facilitate the adhesive attachment to the panel. Preferably, the adhesive is an acrylic adhesive.

Referring now to FIGS. 3 and 4, a thin film of adhesive 9 bonds the stationary end of tether 1 to the panel 3 which includes screw hole 4. This can be easily positioned and applied by an inline operation in an end user environment. As an alternative the adhesive may be applied to the tether covered over by a peelable seal layer and then applied to the panel wherever desired. In either case, the footprint area of adhesive between the tether and the panel would be approximately the same. The moveable end of the tether 1 is attached to the screw 2 by means of a C-shaped clip having jaws 5 at one end of the tether as shown in FIG. 2. The jaws 5 snap and fit into a groove 6 on the screw 2. The groove 6 is circular and allows the screw 2 to rotate freely within the tether clip while remaining engaged with the screw 2. This keeps the tether 1 from wrapping around the screw 2 as the screw is turned. Additionally, the jaws 5 and groove 6 remain out of the path of the clamp load. This is important as it keeps the tether 1 from experiencing significant stresses and the configuration in no way influences the clamp load that the screw 2 may achieve. Another benefit of the jaws 5 is that the end user may simply disassemble the screw to replace worn or broken hardware. This provides the structure with great flexibility and reusability.

It should be understood that there may be other modifications and changes to the present invention that will be obvious to those of skill in the art from the foregoing description, including the different choice of materials and different structural configurations described above. However, the present invention should be limited only by the following claims and their legal equivalents.

What is claimed is:

1. The combination of a tethered fastener attached to a panel, comprising:
a panel having an aperture therein for receiving a screw;
a fastener having a head at one end and an elongate shaft extending from an opposite end;
an elongate tether having attachment means at one end for affixation to said panel; and
a second end of said tether opposite said first end including attachment means for releasably affixing said second end to said head of said screw.

2. The combination of claim 1, wherein said panel affixation means is an adhesive.

3. The combination of claim 2, wherein said tether is composed of nylon.

4. The combination of claim 1, further described in that said elongate shaft is threaded.

5. The combination of claim 1, wherein said second attachment means is a C-shaped clip deformable to provide releasable snap-fit engagement with said head of said fastener.

6. The combination of claim 5 wherein head of said fastener further includes a groove for releasably receiving said C-shaped clip.

7. The combination of a screw and tether, comprising:
a screw having a head at one end and a threaded elongate shaft extending from an opposite end thereof; and
an elongate tether having releasable attachment means at one end for affixing said tether to said screw head.

8. The combination of claim 7 wherein said head of said screw further includes a groove for receiving a portion of said tether.

9. The combination of claim 8 wherein said portion of said tether received by said head of said screw is a C-shaped clip which is deformable to provide a releasable snap-fit engagement with said head of said screw.
